(19) United States
(12) Patent Application Publication
(10) Pub. No.: US 2019/0301653 A1
(43) Pub. Date: Oct. 3, 2019

(54) Fluid-Fitting Adapter

(71) Applicant: Bell Helicopter Textron Inc., Forth Worth, TX (US)

(72) Inventors: Stephen Dickison, Glastonbury, CT (US); Franklin J. Holik, Mansfield, TX (US); Michael Pujol, Dallas, TX (US)

(21) Appl. No.: 15/941,297

(22) Filed: Mar. 30, 2018

(51) Int. Cl. F16L 43/02; B64C 27/12; F16L 43/00

(52) U.S. Cl. CPC F16L 43/02; F16L 43/001; B64C 27/12

(57) ABSTRACT

The present invention includes a fluid-fitting adapter body; a first connection mechanism in fluid communication with the fluid-fitting adapter body, the first connection mechanism including a first piston-style seal, wherein the first connection mechanism is operably configured to seal a connection to a first connection port of a multiport fitting, the multiport fitting including at least one additional connection port proximate to the first connection port, and wherein the first connection mechanism can be secured to the first connection port by manipulation of at least a portion of the first connection mechanism substantially along an axis that is substantially perpendicular to a surface of the multiport fitting in which the first connection port is located; and; a second connection mechanism in fluid communication with the fluid-fitting adapter body, the second connection mechanism being differently configured than the first connection mechanism.

### CROSS-REFERENCE TO RELATED APPLICATIONS

This patent application is related to U.S. provisional patent application Ser. No. 62/399,067 filed on Sep. 23, 2016 entitled “Improved Helicopter Transmission System” and U.S. provisional patent application Ser. No. 62/423,371 filed on Nov. 17, 2016 entitled “Improved Helicopter Transmission System,” all of which are hereby incorporated by reference in its entirety.

### STATEMENT OF FEDERALLY FUNDED RESEARCH

Not applicable.

### TECHNICAL FIELD OF THE INVENTION

The present invention relates in general to the field of fluid-fitting adapters in aircraft systems, and more particularly, to a novel system for an adapter that adapts between at least two styles of fluid-fitting connections for use in an aircraft.

### BACKGROUND OF THE INVENTION

Without limiting the scope of the invention, its background is described in connection with rotorcraft drive systems.

Since their inception, rotorcraft and rotorcraft drive systems have been improved to reduce the possibility of failure during flight. Toward that end, a number of modifications have been made to drive systems to improve reliability. However, despite advances in materials and design, a number of failures continue to occur that affect rotorcraft performance. One example of a problem with current rotorcraft drive systems is that, in some instances, the failure of single drive system component leads to failure of the entire drive system. Another example is a loss of lubrication event that causes the loss of torque transmission by drive system subcomponents such as gearboxes or accessories connected to the main rotor gearbox.

More particularly, the failure of a single gearbox or shaft connected to the main rotor gearbox can significantly impact operations. For example, if there is a loss of lubrication to a gearbox, the gearbox loses torque transmission, causing damage to upstream or downstream components. The same can occur when a shaft becomes unbalanced (or breaks), which can damage couplings, gearboxes and even the main rotor gearbox. Unfortunately, when a portion of a drive system experiences a failure or reduction in performance, the concomitant reduction in power leads to challenges with flight performance.

Thus, a need remains for improving the overall safety and reliability of rotorcraft drive systems that include the connections between the engines and the main rotor gearbox, reduction and accessory gearboxes, shafts, generators, oil pumps, and accessories connected to the main rotor gearbox. A rotorcraft may include a number of fluid fittings that carry various fluids such as fuel, air, aviation oil, and hydraulic fluid. Such fittings must be installed with connections for the flow of fluid into and out of the fittings. Connection mechanisms of two items that must be connected may be configured differently, requiring an adapter to complete the required connection. In some cases, it is useful to have two or more such fluid connections near to each other.

Existing methods and apparatuses for installing fluid fittings make use of adapters and fittings that require significant clearance space for installation and maintenance, e.g., for the use of one or more wrenches to secure connections. The provision of space for installation and maintenance reduces the number of fittings that can be installed in a given space. To increase the number of fittings that can be installed in a space, to minimize the number of fittings required in a system such as a fuel system, and to increase ease of installation and maintenance, thereby lowering costs, an improved system and method for fluid-fitting adapters is desirable.

### SUMMARY OF THE INVENTION

In some embodiments of the disclosure, a fluid-fitting adapter system is disclosed as including a fluid-fitting adapter body; a first connection mechanism in fluid communication with the fluid-fitting adapter body, the first connection mechanism including a first piston-style seal, wherein the first connection mechanism is operably configured to seal a connection to a first connection port of a multiport fitting, the multiport fitting including at least one additional connection port proximate to the first connection port, and wherein the first connection mechanism can be secured to the first connection port by manipulation of at least a portion of the first connection mechanism substantially along an axis that is substantially perpendicular to a surface of the multiport fitting in which the first connection port is located; and a second connection mechanism in fluid communication with the fluid-fitting adapter body, the second connection mechanism being differently configured than the first connection mechanism. In one aspect, the first connection mechanism further includes a flange used to secure the fluid-fitting adapter to the multiport fitting. In another aspect, the first connection mechanism further includes a fastener used to secure the fluid-fitting adapter to the multiport fitting. In another aspect, the fastener is a screw or a bolt. In another aspect, the second connection mechanism includes a non-piston-style seal or a second piston-style seal of a different size than the first piston-style seal of the first connection mechanism. In another aspect, the fluid-fitting adapter is operably configured to carry fuel, air, water, coolant, lubricant, propellant, hydraulic fluid, an environmental-control agent, a fire-suppression agent, a lifting gas, or some combination thereof. In another aspect, the fluid-fitting adapter includes a hose, a tube, or a fitting, or a combination thereof. In another aspect, the fluid-fitting adapter includes a rigid material, flexible material, or a combination thereof.

In some embodiments of the disclosure, a method of adapting a fluid connection is disclosed as including sealing a coupling of a fluid-fitting adapter to a first connection port of a multiport fitting using a first connection mechanism such that the fluid-fitting adapter is in fluid communication with the first connection port, the first connection mechanism including a piston-style seal, wherein the multiport fitting includes at least one additional connection port proximate to the first connection port, and wherein the first connection mechanism can be secured to the first connection port by manipulation of at least a portion of the first connection mechanism substantially along an axis that is substantially perpendicular to a surface of the multiport fitting in which the first connection port is located; and coupling a fluid carrier to a second connection mechanism of the fluid-fitting adapter such that the fluid carrier is in fluid communication with the second connection mechanism. In one aspect, the second connection mechanism includes a non-piston-style seal or a piston-style seal of a different size than the piston-style seal of the first connection mechanism. In another aspect, the method further includes securing the fluid-fitting adapter to the multiport fitting using a flange. In another aspect, the method further includes securing the fluid-fitting adapter to the multiport fitting using a fastener. In another aspect, the fastener is a screw or a bolt. In another aspect, the fluid-fitting adapter is operably configured to carry fuel, air, water, coolant, lubricant, propellant, hydraulic fluid, an environmental-control agent, a fire-suppression agent, a lifting gas, or some combination thereof. In another aspect, the fluid-fitting adapter includes a hose, a tube, a fitting, or a combination thereof. In another aspect, the fluid-fitting adapter includes a rigid material, flexible material, or a combination thereof

In some embodiments of the disclosure, a rotorcraft is disclosed as including a fuselage; one or more fluid-fitting adapters coupled to the fuselage, each fluid-fitting adapter including a fluid-fitting adapter body; a first connection mechanism in fluid communication with the fluid-fitting adapter body, the first connection mechanism including a piston-style seal, wherein the first connection mechanism is operably configured to seal a connection to a first connection port of a multiport fitting, the multiport fitting including at least one additional connection port proximate to the first connection port, and wherein the first connection mechanism can be secured to the first connection port by manipulation of at least a portion of the first connection mechanism substantially along an axis that is substantially perpendicular to a surface of the multiport fitting in which the first connection port is located; and a second connection mechanism in fluid communication with the fluid-fitting adapter body, the second connection mechanism being differently configured than the first connection mechanism.

In addition to the foregoing, various other method, system, and apparatus aspects are set forth in the teachings of the present disclosure, such as the claims, text, and drawings forming a part of the present disclosure.

The foregoing is a summary and thus contains, by necessity, simplifications, generalizations, and omissions of detail. Consequently, those skilled in the art will appreciate that this summary is illustrative only and is not intended to be in any way limiting. These aspects, features, and advantages of the devices, processes, and other subject matter described herein will be become apparent in the teachings set forth herein.

### BRIEF DESCRIPTION OF THE DRAWINGS

For a more complete understanding of the features and advantages of the present invention, reference is now made to the detailed description of the invention along with the accompanying figures, in which:

FIG. 1 shows a side view of a helicopter according to a particular embodiment of the present application;

FIG. 2 shows a partial cross-section, perspective view of a helicopter according to an embodiment of the present application;

FIG. 3 shows a perspective view of a fluid-fitting adapter system according to a particular embodiment of the present invention;

FIGS. 4A and 4B show a perspective views of multiport fittings according to particular embodiments of the present invention;

FIG. 5 shows a perspective view of fluid-fitting adapter systems and a multiport fitting according to a particular embodiment of the present invention;

FIG. 6 shows a perspective view of a multiport fitting and fluid-fitting adapter systems according to a particular embodiment of the present invention; and

FIG. 7 shows a flowchart of a method of adapting a fluid connection that depicts an embodiment of the present invention.

### DETAILED DESCRIPTION OF THE INVENTION

Illustrative embodiments of the system of the present application are described below.

In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

The present invention is directed to a novel fluid fitting, e.g., for use with fuel lines, that avoids the need for a large open area adjacent the connections, which are currently required for operating wrenches during installation and removal of the fittings. The present invention overcomes these space limitation problems while still maintaining optimal operation and access to fluid lines. The present invention also expands the possible locations for fluid fittings that maximize design efficiency, while also reducing maintenance time. Furthermore, the fluid fitting of the present invention provides for one or more adaptors that connect two styles of fluid fittings while creating space so that multiple fittings can be installed in a small area. The compact design of the present invention overcomes the devices and methods used previously in which smaller fittings had to be used because they required significant clearance space for installation.

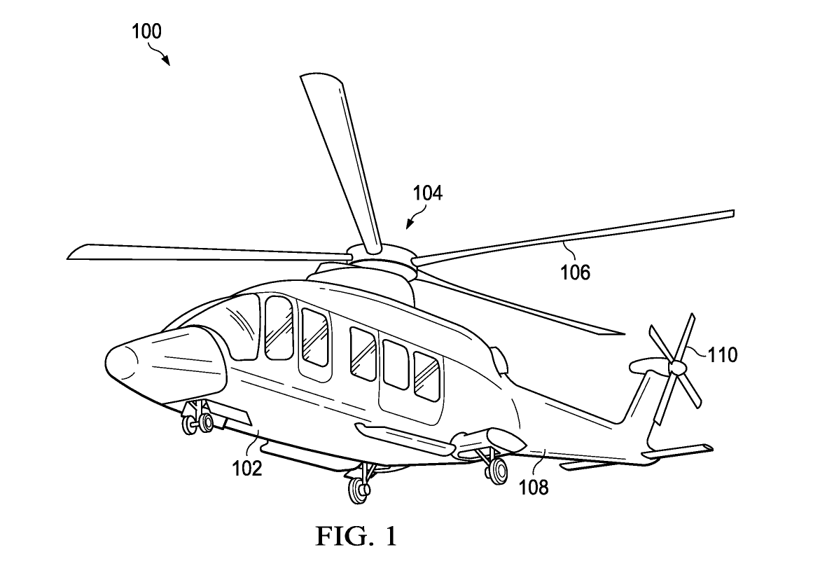

FIG. 1 shows an aircraft 100 in accordance with a preferred embodiment of the present application. In the exemplary embodiment, aircraft 100 is a helicopter having a fuselage 102 and a rotor system 104 carried thereon. A plurality of rotor blades 106 is operably associated with a rotor system 104 for creating flight. A tail boom 108 is depicted that further includes tail rotor 110.

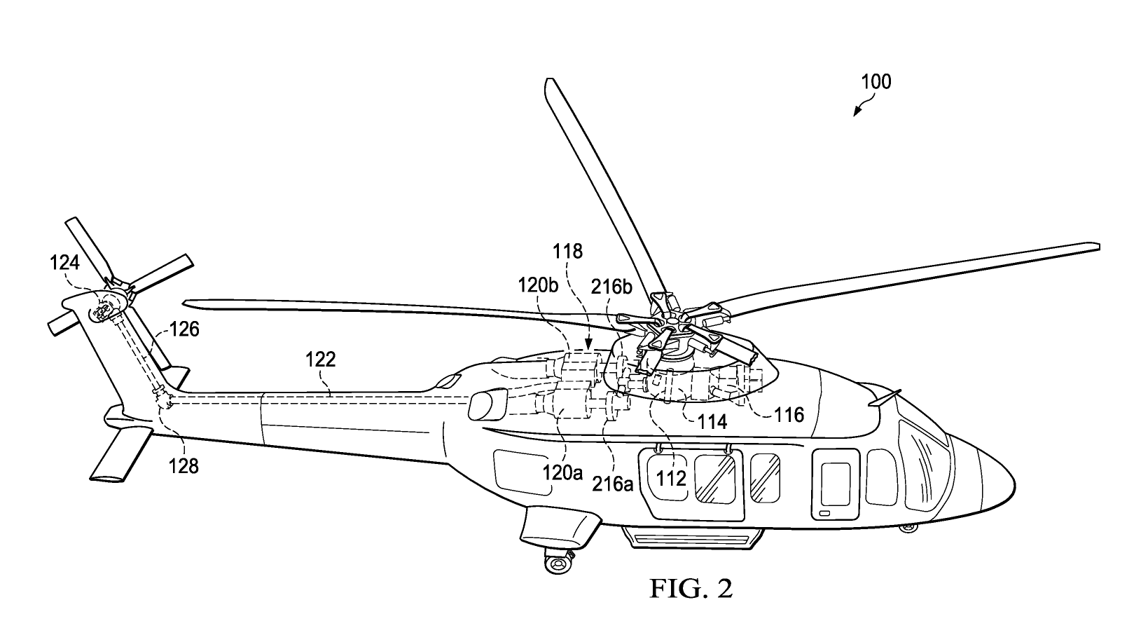

For example, FIG. 2 shows a partial cross-section perspective view of aircraft 100 that includes additional detail of the present invention. Aircraft 100 further includes a rotor mast 112, which is connected to the main rotor gearbox (MRGB) 114. The MRGB 114 is connected to one or more accessory gear boxes 116 and one or more reduction gearboxes (RGB) 216a, 216b, hydraulic pump(s) and generator(s). Each RGB 216a, 216b is connected to one or more engines 120a, 120b, which are within an engine compartment 118. A tail rotor drive shaft 122 transmits mechanical rotation to the tail rotor gearbox 124, which is connected via tail rotor drive shaft 126 and intermediate gear box 128.

The drive system and subcomponents of aircraft 100 were developed to address the failures common to rotorcraft drive systems and is based on a completely new design and application of new technology to rotorcraft safety. More particularly, the new rotorcraft drive system is focused in an unparalleled manner on safety and redundancy. The goal of safety drove the design and development of the unique layout and configuration of the rotorcraft drive system described herein, which incorporates unique features and system separation that protects primary aircraft systems from the most common drive system failures. The drive system has also been designed to maximize the operational capability in the event of an uncommon failure, such as a loss of lubrication.

The drive system and subcomponents of aircraft 100 overcome many drive system failures by including one or more of the following design features: (1) minimize the number of single path drive system components; (2) provide maximum system separation and redundancy; (3) minimize maintenance requirements and maintenance related incidents; (4) minimize the potential of loss of lubrication events; and/or (5) maximize main rotor gearbox loss of lubrication capability. The rotorcraft drive system includes, e.g., dual engine reduction gearboxes completely isolated from the remainder of drive system via freewheeling clutches in the main rotor gearbox, dual accessory gearboxes separate from the main rotor gearbox, and the distribution of the gearbox driven accessories among the separate systems, among other improvements.

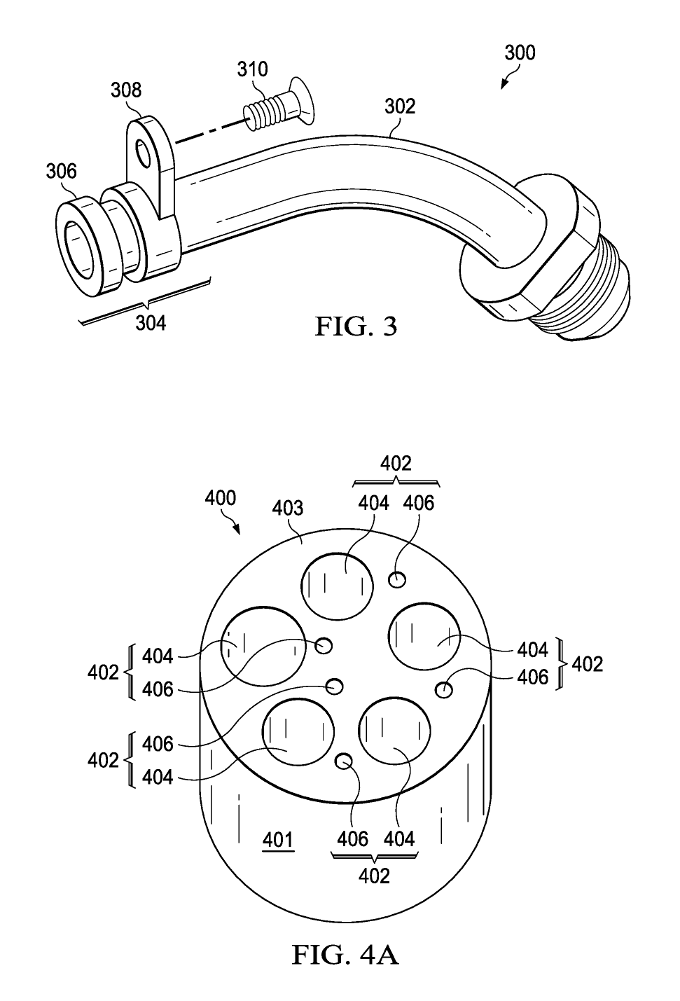

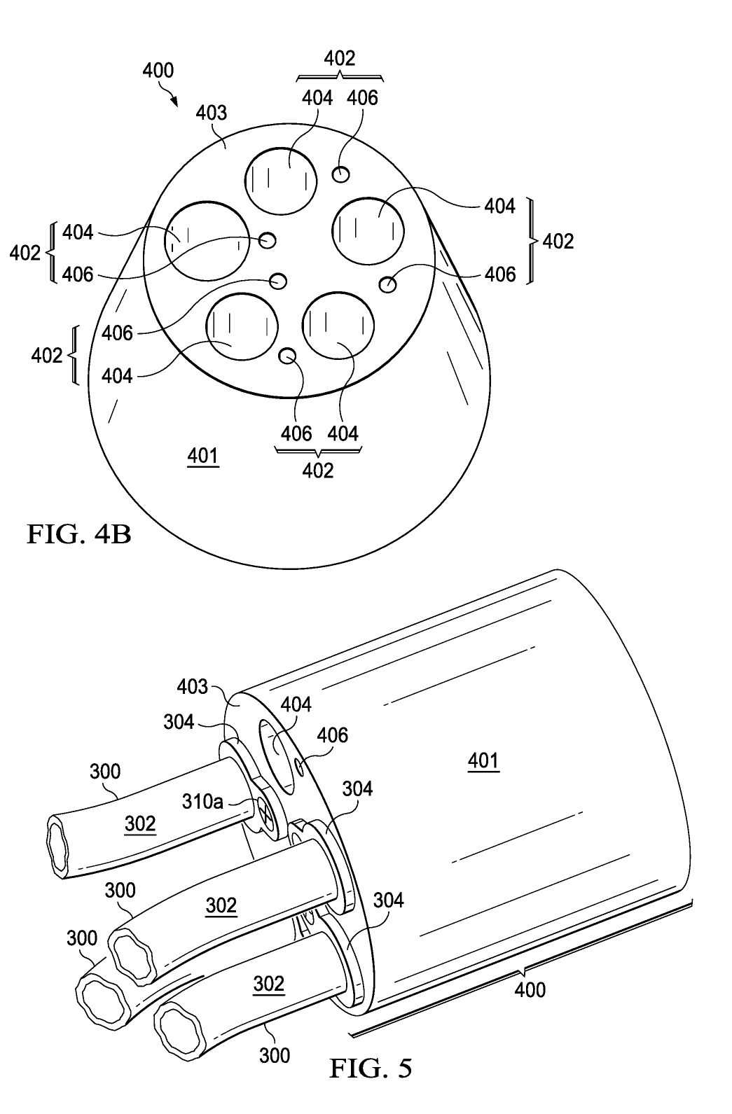

FIG. 3 shows a perspective view of a fluid-fitting adapter 300 according to a particular embodiment of the present invention. Aircraft 100 and its engine 120, main rotor gearbox 114, and other systems require one or more fluids, such as fuel, air, water, coolant, lubricant, propellant, hydraulic fluid, environmental-control agents (e.g., a refrigerant), fire-suppression agents, lifting gases, some other fluid, or some combination thereof. Such fluids are transported within aircraft 100 via a variety of hoses, tubes, fittings, or some combination thereof. These fluid carriers that transport fluids within aircraft 100 may have a variety of differently configured connection mechanisms with systems such as engine 120, main rotor gearbox 114, other systems, or other fluid carriers, to couple the fluid carriers to other items, and some of these connection mechanisms occupy a relatively large space or require relatively large clearance spaces for installation, inspection, and maintenance. Fluid-fitting adapter 300 is used to connect a fluid carrier to a multiport fitting 400 (not shown) that has at least two relatively compact connection ports, each of which require relatively little space for installation, inspection, and maintenance, and which are proximate to each other. Fluid-fitting adapter may include a rigid material, a flexible material, or some combination thereof. Fluid-fitting adapter 300 includes an adapter body 302. The fluid-fitting adapter 300 also includes piston-style connection mechanism 304 at one end, and piston-style connection mechanism 304 includes a piston-style seal 306, a flange 308, and a fastener 310. The piston-style seal 306 is used to seal a connection between the fluid-fitting adapter 300 and the multiport fitting 400, placing the fluid-fitting adapter 300 in fluid communication with the multiport fitting 400 with substantially no leakage. The flange 308 is used to secure the fluid-fitting adapter 300 to the multiport fitting 400 with fastener 310, e.g., a screw or a bolt. Generally, the present invention includes embodiments that allow a connection mechanism such as piston-style connection mechanism 304, which includes portions that permit the connection mechanism to be secured to a multiport fitting such as multiport fitting 400, e.g., flange 308 and fastener 310, by manipulation of at least a portion of the connection mechanism along an axis substantially parallel to the longitudinal axis of the multiport fitting. For example, piston-style connection mechanism 304 can be secured to multiport fitting 400 by manipulation of flange 308 and fastener 310 substantially along an axis that is substantially perpendicular to a surface of the multiport fitting in which a connection port is located (see FIG. 4A), by insertion of fastener 310 through flange 308 into a fastener receptacle (see FIG. 4A). The skilled artisan will recognize that the present invention encompasses embodiments that may or may not make use of the specific mechanisms used for exemplary purposes herein.

At the other end of the fluid-fitting adapter 300, there is another type of connection mechanism that is differently configured than piston-style connection mechanism 304, e.g., a non-piston-style connection mechanism or a piston-style connection mechanism with a piston-style seal that is of a different size or configuration than piston-style connection mechanism 304. A flared end fitting is shown, but the connection mechanism at the other end of the fluid-fitting adapter 300 may be, e.g., a flareless fluid end fitting, a flange seal interface, an open tube, an open tube with a beaded end for a hose clamp, a specially designed fitting or coupling, or some other type of connection mechanism. The skilled artisan will recognize that, while fluid-fitting adapter 300 is shown with a connection mechanism at each of two ends, that in an alternate embodiment of the present invention, a fluid-fitting adapter may have two or more ends, such as a T-shaped adapter, each with a connection mechanism. Fluid-fitting adapter 300 not only permits two or more couplings in a relatively small space; it also permits such couplings to fluid carriers with connection mechanisms with differently configured connection mechanisms.

FIG. 4A shows a perspective view of multiport fitting 400 according to a particular embodiment of the present invention. Multiport fitting 400 is capable of carrying fluid such as those fluids mentioned herein. Multiport fitting 400 includes a multiport fitting body 401, one or more connection ports 402 in multiport fitting body 401, each of which includes a seal receptacle 404 and a fastener receptacle 406. Multiport fitting 400 also has a surface in which the one or more connection ports are located, surface 403. When piston-style seal 306 (not shown) is inserted into seal receptacle 404, fluid-fitting adapter 300 (not shown) can be secured to multiport fitting 400 by inserting fastener 310 (not shown) through flange 308 (not shown) into fastener receptacle 406.

FIG. 4B shows a perspective view of another multiport fitting 400 according to a particular embodiment of the present invention. Multiport fitting 400 includes a multiport fitting body 401, one or more connection ports 402 in multiport fitting body 401, each of which includes a seal receptacle 404 and a fastener receptacle 406. Multiport fitting 400 also has a surface in which the one or more connection ports are located, surface 403. Here, surface 403 is the surface of a truncated cone, in which the one or more connection ports 402 are located. When piston-style seal 306 (not shown) is inserted into seal receptacle 404, fluid-fitting adapter 300 (not shown) can be secured to multiport fitting 400 by inserting fastener 310 (not shown) through flange 308 (not shown) into fastener receptacle 406.

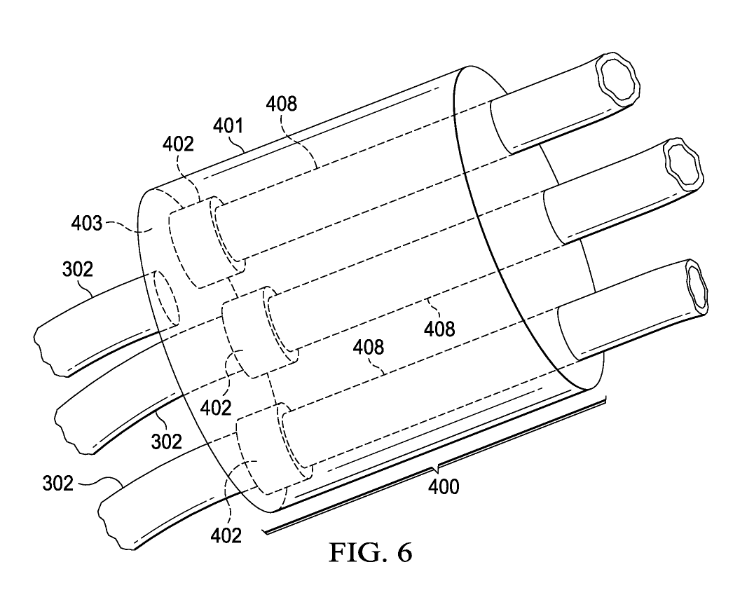

FIG. 5 shows a perspective view of multiport fitting 400 and a plurality of fluid-fitting adapters 300 and according to a particular embodiment of the present invention. Several fluid-fitting adapters 300 are shown with their respective piston-style seals 306 inserted into seal receptacles 404 (not shown because obscured by piston-style connection mechanisms 304). A seal receptacle 404 without a piston-style seal 306 inserted is shown. For one of the illustrated piston-style seals 306 inserted into a seal receptacle 404, the head 310a of a fastener 310 is shown. A fastener receptacle 406 into which a fastener 310 is not inserted is shown for clarity. The surface 403 of multiport fitting 400 is shown.

FIG. 6 shows a perspective view of a multiport fitting and a plurality of fluid-fitting adapters according to a particular embodiment of the present invention. Some components of multiport fitting are omitted for clarity. Multiport fitting 400 is shown transparent to offer a view of a plurality of multiport-adapter fluid carriers 408. The surface 403 of multiport fitting 400 is shown. Each multiport-adapter fluid carrier 408 is in fluid communication with one of the connection ports 402 and is operably configured to carry fluid away to or from the connection port 402 with which it is in fluid communication. Multiport fitting body 401 may also be in direct fluid communication with an aircraft system to or from which it communicates fluids, such as a fuel system, an engine 120, a gearbox such as main rotor gearbox 114, a cooling system, a lubrication system, a propellant system, a hydraulic system, an environmental control system, a fire-suppression system, a vacuum-gyroscope system (including, e.g., vacuum-driven gyroscopic instruments such as an attitude indicator or a gyroscopic compass), a lifting-gas system (in, e.g., aeronautical balloons), or some other system, and multiport fitting body 401 may be operably configured to carry fluid directly to or from the aircraft system with which it is in direct fluid communication.

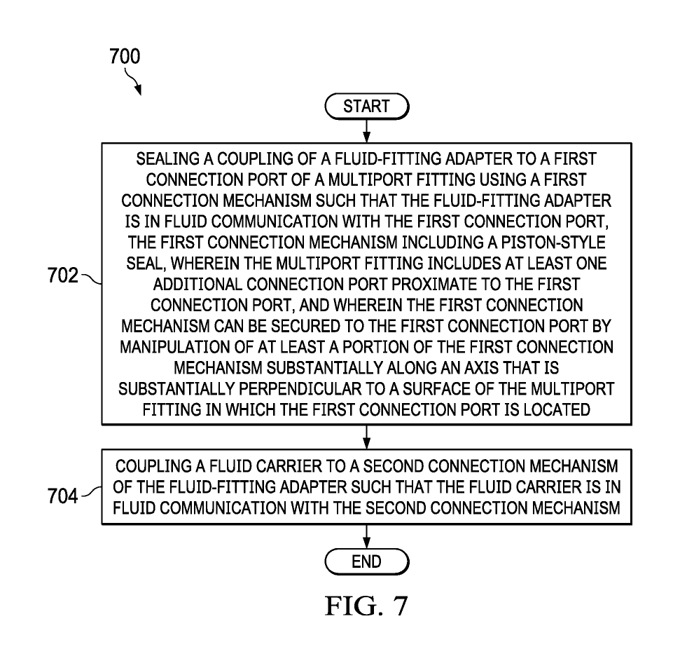

Referring now to FIG. 7, a flowchart of a method 700 of adapting a fluid connection illustrates an embodiment of the present invention. The method 700 includes step 702, sealing a coupling of a fluid-fitting adapter to a first connection port of a multiport fitting using a first connection mechanism such that the fluid-fitting adapter is in fluid communication with the first connection port, the first connection mechanism including a piston-style seal, wherein the multiport fitting includes at least one additional connection port proximate to the first connection port, and wherein the first connection mechanism can be secured to the first connection port by manipulation of at least a portion of the first connection mechanism substantially along an axis that is substantially perpendicular to a surface of the multiport fitting in which the first connection port is located. The method 700 also includes step 704, coupling a fluid carrier to a second connection mechanism of the fluid-fitting adapter such that the fluid carrier is in fluid communication with the second connection mechanism.

The skilled artisan will recognize that the novel fluid-fitting adapter system and method of adapting a fluid connection of the present invention will permit the placement of more fluid-fitting adapters 300 and a multiport fitting 400 into a given space and will permit easier access to the connections of the fluid-fitting adapters, lowering operation and maintenance costs. The skilled artisan will also recognize that the novel fluid-fitting adapter system and method of adapting a fluid connection of the present invention may be used in a wide variety of aeronautical and aerospace vehicles such as rotorcraft, airplanes, aeronautical balloons, rockets, missiles, and spacecraft, as well as a wide variety of other applications that use fluids.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of” As used herein, the phrase “consisting essentially of requires the specified integer(s) or steps as well as those that do not materially affect the character or function of the claimed invention. As used herein, the term “consisting” is used to indicate the presence of the recited integer (e.g., a feature, an element, a characteristic, a property, a method/process step, or a limitation) or group of integers (e.g., feature(s), element(s), characteristic(s), property(ies), method/process(s) steps, or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about,” “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the devices and/or methods disclosed and claimed herein can be made and executed without undue experimentation in light of the present disclosure. While the devices and/or methods of this invention have been described in terms of particular embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope, and concept of the invention as defined by the appended claims.

Furthermore, no limitations are intended to the details of construction or design herein shown, other than as described in the claims below. It is therefore evident that the particular embodiments disclosed above may be altered or modified and all such variations are considered within the scope and spirit of the disclosure. Accordingly, the protection sought herein is as set forth in the claims below.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order.

To aid the Patent Office, and any readers of any patent issued on this application in interpreting the claims appended hereto, applicants wish to note that they do not intend any of the appended claims to invoke 35 U.S.C. § 112(f) as it exists on the date of filing hereof unless the words “means for” or “step for” are explicitly used in the particular claim.

What is claimed is:

1. A fluid-fitting adapter system, comprising:
a fluid-fitting adapter body;
a first connection mechanism in fluid communication with the fluid-fitting adapter body, the first connection mechanism comprising a first piston-style seal, wherein the first connection mechanism is operably configured to seal a connection to a first connection port of a multiport fitting, the multiport fitting comprising at least one additional connection port proximate to the first connection port, and wherein the first connection mechanism can be secured to the first connection port by manipulation of at least a portion of the first connection mechanism substantially along an axis that is substantially perpendicular to a surface of the multiport fitting in which the first connection port is located; and
a second connection mechanism in fluid communication with the fluid-fitting adapter body, the second connection mechanism being differently configured than the first connection mechanism.

2. The system of claim 1, wherein the first connection mechanism further comprises a flange used to secure the fluid-fitting adapter to the multiport fitting.

3. The system of claim 1, wherein the first connection mechanism further comprises a fastener used to secure the fluid-fitting adapter to the multiport fitting.

4. The system of claim 3, wherein the fastener is a screw or a bolt.

5. The system of claim 1, wherein the second connection mechanism comprises a non-piston-style seal or a second piston-style seal of a different size than the first piston-style seal of the first connection mechanism.

6. The system of claim 1, wherein the fluid-fitting adapter is operably configured to carry fuel, air, water, coolant, lubricant, propellant, hydraulic fluid, an environmental-control agent, a fire-suppression agent, a lifting gas, or some combination thereof

7. The system of claim 1, wherein the fluid-fitting adapter comprises a hose, a tube, or a fitting, or a combination thereof.

8. The system of claim 1, wherein the fluid-fitting adapter comprises a rigid material, flexible material, or a combination thereof

9. A method of adapting a fluid connection, comprising:
sealing a coupling of a fluid-fitting adapter to a first connection port of a multiport fitting using a first connection mechanism such that the fluid-fitting adapter is in fluid communication with the first connection port, the first connection mechanism comprising a piston-style seal, wherein the multiport fitting comprises at least one additional connection port proximate to the first connection port, and wherein the first connection mechanism can be secured to the first connection port by manipulation of at least a portion of the first connection mechanism substantially along an axis that is substantially perpendicular to a surface of the multiport fitting in which the first connection port is located; and
coupling a fluid carrier to a second connection mechanism of the fluid-fitting adapter such that the fluid carrier is in fluid communication with the second connection mechanism.

10. The method of claim 9, wherein the second connection mechanism comprises a non-piston-style seal or a piston-style seal of a different size than the piston-style seal of the first connection mechanism.

11. The method of claim 9, further comprising securing the fluid-fitting adapter to the multiport fitting using a flange.

12. The method of claim 9, further comprising securing the fluid-fitting adapter to the multiport fitting using a fastener.

13. The method of claim 12, wherein the fastener is a screw or a bolt.

14. The method of claim 9, wherein the fluid-fitting adapter is operably configured to carry fuel, air, water, coolant, lubricant, propellant, hydraulic fluid, an environmental-control agent, a fire-suppression agent, a lifting gas, or some combination thereof.

15. The method of claim 9, wherein the fluid-fitting adapter comprises a hose, a tube, a fitting, or a combination thereof

16. The method of claim 9, wherein the fluid-fitting adapter comprises a rigid material, flexible material, or a combination thereof.

17. A rotorcraft, comprising:
a fuselage;
one or more fluid-fitting adapters coupled to the fuselage, each fluid-fitting adapter comprising:
a fluid-fitting adapter body;
a first connection mechanism in fluid communication with the fluid-fitting adapter body, the first connection mechanism comprising a piston-style seal, wherein the first connection mechanism is operably configured to seal a connection to a first connection port of a multiport fitting, the multiport fitting comprising at least one additional connection port proximate to the first connection port, and wherein the first connection mechanism can be secured to the first connection port by manipulation of at least a portion of the first connection mechanism substantially along an axis that is substantially perpendicular to a surface of the multiport fitting in which the first connection port is located; and
a second connection mechanism in fluid communication with the fluid-fitting adapter body, the second connection mechanism being differently configured than the first connection mechanism.
